(19) United States
(12) Patent Application Publication
(10) Pub. No.: US 2019/0212953 A1
(43) Pub. Date: Jul. 11, 2019

(54) IMAGE FORMING APPARATUS AND INFORMATION PROCESSING APPARATUS

(71) Applicant: Konica Minolta, Inc., Tokyo (JP)

(72) Inventor: Yuya WATANABE, Niiza-shi (JP)

(73) Assignee: Konica Minolta, Inc., Tokyo (JP)

(21) Appl. No.: 16/232,602

(22) Filed: Dec. 26, 2018

(30) Foreign Application Priority Data
Jan. 10, 2018 (JP) 2018-001621

(51) Int. Cl. G06F 3/12

(52) U.S. Cl. CPC G06F 3/1208; G06F 3/1258; G06F 3/1279; G06F 3/1242

(57) ABSTRACT

The visibility of a person to view a whole poster may degrade depending on positions to place joints of a plurality of printouts to create the poster.

An image forming apparatus specifies a first region capable of placing a plurality of printout joints based on a document image acquired from a poster print job, calculates a conspicuousness degree for each unit region assigned a specified position with reference to a whole document image, and settles a joint position to place a joint, namely, a position to pass through the first region and not to pass through a unit region whose conspicuousness degree is higher than a predetermined threshold value.

### CROSS-REFERENCE TO RELATED APPLICATIONS

The entire disclosure of Japanese Patent Application No. 2018-1621, filed on Jan. 10, 2018, is incorporated herein by reference in its entirety.

### BACKGROUND

### Technological Field

The present invention relates to an image forming apparatus and an information processing apparatus.

### Description of the Related Art

Conventionally, for example, there is known a process that prints an original image supplied from a PC (Personal Computer) terminal by splitting the image into a plurality of sheets of paper and tiles a plurality of printouts to create a single poster. When a poster is created by tiling a plurality of printouts, edges of adjacent sheets are easily misaligned and joints between printouts are obviously visible. The visibility of a poster may degrade due to positions or colors of the printout joints. There are known technologies to adjust printout joints as disclosed in Patent Literatures 1 and 2 described below.

Patent Literature 1 discloses the technology that prints sheets of paper by laying out objects extracted from an original image as a print target so as to fit the objects onto the sheets.

Patent Literature 2 discloses the technology that provides partition lines for monotonous image areas within a specified range of an original image and splits the original image into areas each of which is smaller than or equal to the size of a recording material.

### CITATION LIST

### Patent Literature

Patent Literature 1: JP 2015-87974 A
Patent Literature 2: JP 2001-309161 A

### SUMMARY

The technology disclosed in Patent Literature 1 provides joints so as to avoid an object contained in an original image and is therefore expected to improve the visibility. Generally, however, a poster contains many objects, and it is difficult to provide joints so as to avoid all the objects. The technology disclosed in Patent Literature 1 settles a joint position by evaluating pixels based on a local criterion whether the object color approximates to the background color adjacent to the object. The settled joint inevitably passing through an object degrades the visibility of a person who views the whole of a poster.

The technology disclosed in Patent Literature 2 extracts edges contained in an original image and provides joints so as to minimize the number of intersections with the edges. The technology disclosed in Patent Literature 2 prevents the visibility from degrading due to misaligned edges on the joints when an image is formed on each sheet at an excessively misaligned position. However, the poster visibility also depends on factors other than the edges. No consideration is given for the visibility degradation when no edges are misaligned. For example, edges are usually not detected on a poorly contrasted background. However, a white-color joint is easily visible on a dark color background.

The present invention has been made in consideration of the foregoing. It is an object of the invention to improve the visibility of a poster created by tiling a plurality of printouts.

In order to achieve at least one of the above-mentioned objects, an image forming apparatus according to one aspect of the present invention includes: a first region specifier that specifies a first region capable of placing joints of a plurality of printouts based on a document image acquired from a poster print job to print a poster created by tiling the printouts; a conspicuousness degree calculator that calculates a conspicuousness degree for each unit region included in the document image and assigned a specified position with reference to the whole document image; and a joint position settler that settles a joint position to place the joint, namely, a position to pass through the specified first region and not to pass through the unit region assigned the conspicuousness degree higher than a predetermined threshold value.

The above-mentioned image forming apparatus represents one mode of the present invention. An information processing apparatus reflecting one aspect of the present invention also includes a configuration comparable to that of the image forming apparatus reflecting one aspect of the present invention.

The foregoing and other issues, configurations, and effects will become more apparent from the description of the preferred embodiments of the invention given below.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram illustrating a configuration of the image forming system according to a first embodiment of the present invention;

FIG. 2 is a schematic diagram illustrating a hardware configuration of the image forming apparatus according to the first embodiment of the present invention;

FIG. 3 is a function block diagram illustrating an internal configuration of the image forming apparatus according to the first embodiment of the present invention;

FIG. 4 is a function block diagram illustrating an internal configuration of an image processor according to the first embodiment of the present invention;

FIG. 5 is an explanatory diagram illustrating printouts generated by three types of print modes;

FIG. 6 is an explanatory diagram illustrating a first region according to the first embodiment of the present invention;

FIG. 7 is an explanatory diagram illustrating an example of shifting a document image within four sheets placed flat according to the first embodiment of the present invention;

FIG. 8 is an explanatory diagram illustrating a conspicuousness map generated from a document image and a second region specified from the conspicuousness map according to the first embodiment of the present invention;

FIG. 9 is an explanatory diagram illustrating a sheet joint position settled without specifying a poster background color according to the first embodiment of the present invention;

FIG. 10 is an explanatory diagram illustrating the generation of a conspicuousness map based on a document image containing white joints drawn when using white as a poster background color according to the first embodiment of the present invention;

FIG. 11 is a flowchart illustrating a process to settle a printout joint position according to the first embodiment of the present invention;

FIG. 12 is a flowchart illustrating a process of an image processor to generate a conspicuousness map according to the first embodiment of the present invention;

FIG. 13 is a flowchart illustrating a process of a background color acquirer to acquire a poster background color from a storage according to the first embodiment of the present invention;

FIG. 14 is a schematic diagram illustrating a configuration of the image forming system according to a second embodiment of the present invention; and

FIG. 15 is a block diagram illustrating an internal configuration of an information processing apparatus according to the second embodiment of the present invention.

### DETAILED DESCRIPTION OF EMBODIMENTS

Hereinafter, one or more embodiments of the present invention will be described with reference to the drawings. However, the scope of the invention is not limited to the disclosed embodiments. In the specification and the accompanying drawings, constituent elements having substantially the same functions or configurations are designated by the same reference numerals and a duplicate description is omitted.

### First Embodiment

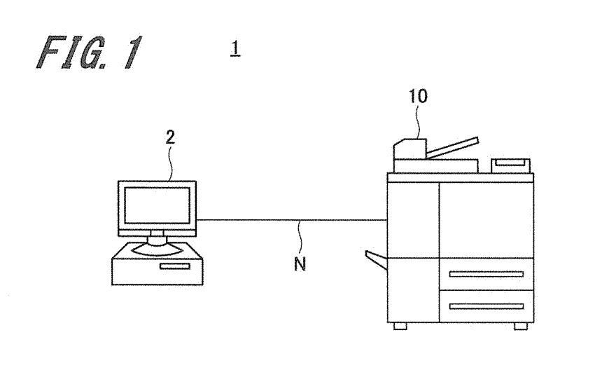

FIG. 1 is a schematic diagram illustrating a configuration of an image forming system 1.

The image forming system 1 includes a PC terminal 2 and an image forming apparatus 10 connected to communication network N.

The PC terminal 2 transmits a job to the image forming apparatus 10. According to the present embodiment, a job transmitted from the PC terminal 2 corresponds to a poster print job that prints a poster created by tiling a plurality of printouts.

The image forming apparatus 10 generates a printout containing an image formed on a sheet of paper based on the job received from the PC terminal 2. According to the present embodiment, the image forming apparatus 10 generates a plurality of printouts including joints at joint positions settled so as not to degrade the human visibility.

### Hardware Configuration of the Image Forming Apparatus

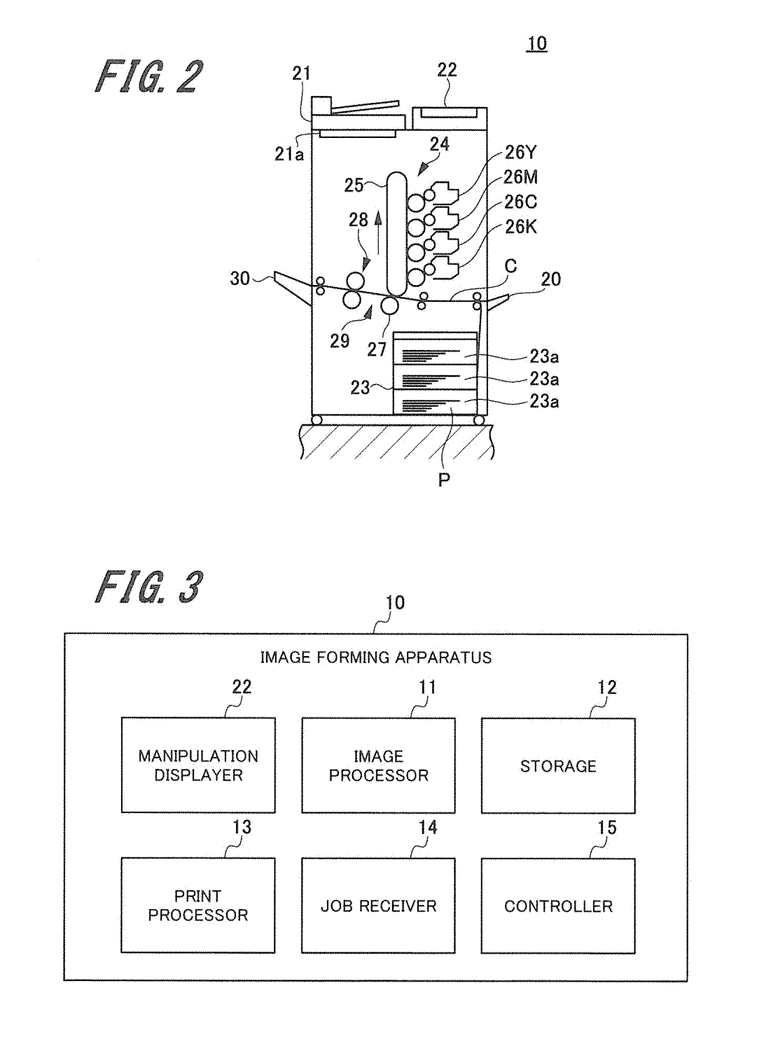

FIG. 2 is a schematic diagram illustrating a hardware configuration of the image forming apparatus 10. The image forming apparatus 10 uses the electrophotographic system to form images using the static electricity and is provided as a tandem color image forming apparatus that overlays toner images in four colors such as yellow (Y), magenta (M), cyan (C), and black (K), for example. The image forming apparatus 10 includes a manual feed tray 20, an automatic document feeder 21, a manipulation displayer 22, a sheet feeder 23, an image former 24, an intermediate transfer belt 25 (image carrier), a secondary transferrer 27, a fuser 28, a transporter 29, and a catch tray 30.

The manual feed tray 20 is removed from the image forming apparatus body for use when an image is to be formed on sheet P, namely, the type of paper not mounted on the sheet feeder 23. The manual feed tray 20 is tilted at a predetermined angle upward with reference to a horizontal direction and is capable of mounting a plurality of sheets P. Sheet P is supplied from the manual feed tray 20 to transport path C inside the image forming apparatus body.

The automatic document feeder 21 automatically feeds documents to be read. A scanner 21a is provided below the automatic document feeder 21 and is capable of reading images from a document that is placed on a platen glass at the top of the image forming apparatus 10 or is automatically fed by the automatic document feeder 21.

The manipulation displayer 22 includes a function as a manipulator that instructs the start of a job such as an image forming process. The manipulation displayer 22 is comprised of a touch panel including an LCD (Liquid Crystal Display), for example, and enables a user to perform operations and display the information. The manipulation displayer 22 is used as a manipulator and a displayer. The manipulator can be comprised of a mouse or a tablet so as to be configured independently of the displayer.

The sheet feeder 23 includes a plurality of sheet storages 23a capable of storing sheets differing in sizes and types. The sheet feeder 23 selects the corresponding sheet storage 23a based on an instruction from the image forming apparatus 10, takes sheet P out of the sheet storage 23a, and delivers sheet P to transport path C.

The image former 24 includes four image forming units 26Y, 26M, 26C, and 26K to form toner images in yellow, magenta, cyan, and black. The image former 24 forms a toner image in yellow, magenta, cyan, and black by controlling operations of the image forming units 26Y, 26M, 26C, and 26K of the image former 24. The image forming apparatus 10 includes a plurality of rollers (transport rollers) as the transporter 29 to transport sheet P to transport path C. Normally, the rollers are each configured as a roller pair.

In image forming mode, the image forming apparatus 10 electrically charges photoreceptors provided for the image forming units 26Y, 26M, 26C, and 26K, exposes the photoreceptors to eliminate the electric charge, and forms electrostatic latent images on the photoreceptors. A developer is then used to apply the toner to the electrostatic latent images on the yellow, magenta, cyan, and black photoreceptors to form toner images in the respective colors. As a primary transfer, the toner images formed on the yellow, magenta, cyan, and black photoreceptors are sequentially transferred to the surface of the intermediate transfer belt 25 rotating in the direction of the arrow.

As a secondary transfer, the secondary transferrer 27 (secondary transfer roller) transfers the color toner images primarily transferred to the intermediate transfer belt 25 then to sheet P that is supplied from the sheet feeder 23 and is transported by the transporter 29 at a specified speed. A color image is formed by secondarily transferring the color toner images on the intermediate transfer belt 25 to sheet P. The image forming apparatus 10 transports sheet P containing the formed color toner image to the fuser 28.

The fuser 28 performs a fusing process on sheet P where the color toner image is formed. The fuser 28 heats sheet P transported by the transporter 29 to a predetermined fusing temperature and applies a pressure to sheet P to fuse the toner image transferred to sheet P onto sheet P. The fuser 28 includes an upper fusing roller and a lower fusing roller as fusing members, for example. The upper fusing roller and the lower fusing roller are positioned so as to be pressed against each other and form a fusing nipper as a presser between the upper fusing roller and the lower fusing roller.

An unshown heater is provided inside the upper fusing roller. Radiation heat from the heater heats a roller portion at the periphery of the upper fusing roller. The secondary transferrer 27 transports sheet P to the fusing nipper so that the surface (targeted at fusing) containing the transferred toner image faces the upper fusing roller. Sheet P passing through the fusing nipper is pressed by the upper fusing roller and the lower fusing roller and is heated by the heat from the roller portion of the upper fusing roller. Sheet P fused by the fuser 28 is ejected as a printout to the catch tray 30.

### Example Internal Configuration of the Image Forming Apparatus

FIG. 3 is a function block diagram illustrating an internal configuration of the image forming apparatus 10.

The image forming apparatus 10 includes a manipulation displayer 22, an image processor 11, a storage 12, a print processor 13, a job receiver 14, and a controller 15.

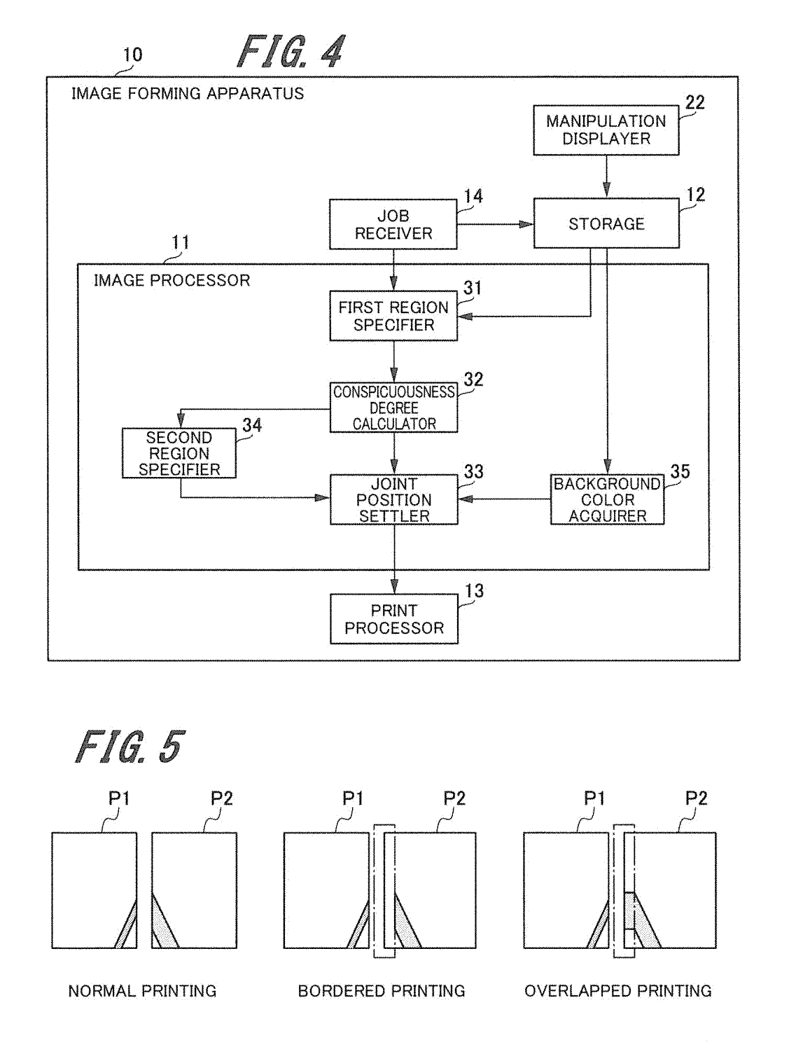

The image processor 11 performs a predetermined process on a document image acquired from a poster print job stored in the storage 12. The image processor 11 may perform the process immediately after the job receiver 14 receives the poster print job. An example internal configuration of the image processor 11 will be described later with reference to FIG. 4. The process performed by the image processor 11 will be described in detail with reference to FIG. 5 and later.

The storage 12 is provided as RAM (Random Access Memory) or HDD (Hard Disk Drive), for example, and stores various types of data such as a poster print job received by the job receiver 14 or a document image processed by the image processor 11. The poster print job prints a poster created by tiling a plurality of printouts. The storage 12 also stores a poster background color specified by a user using the manipulation displayer 22. The HDD as the storage 12 is used as an example of a non-transitory computer-readable storage medium storing a program performed by the CPU. The non-transitory computer-readable storage medium is provided as not only the HDD but also CD-ROM or DVD-ROM.

The print processor 13 prints document images split by the image processor 11 based on the poster print job and joint positions settled by the joint position settler 33 (see FIG. 4 described later). At this time, the print processor 13 control operations of the image former 24, the fuser 28, and the transporter 29 described above. The document image is split into a plurality of sheets that are printed and are ejected as printouts. A user can tile the ejected printouts on a wall so that a plurality of printouts can be used as a single poster.

The job receiver 14 receives the poster print job from a print controller or the PC terminal unshown and stores the poster print job in the storage 12.

The controller 15 controls operations of the components in the image forming apparatus 10. The function of the controller 15 can be implemented by executing a program or parameters the CPU (Central Processing Unit) included in the image forming apparatus 10 reads from the storage 12, for example.

### Example Internal Configuration of the Image Processor

FIG. 4 is a function block diagram illustrating an internal configuration of the image processor 11.

The image processor 11 includes a first region specifier 31, a conspicuousness degree calculator 32, a joint position settler 33, a second region specifier 34, and a background color acquirer 35.

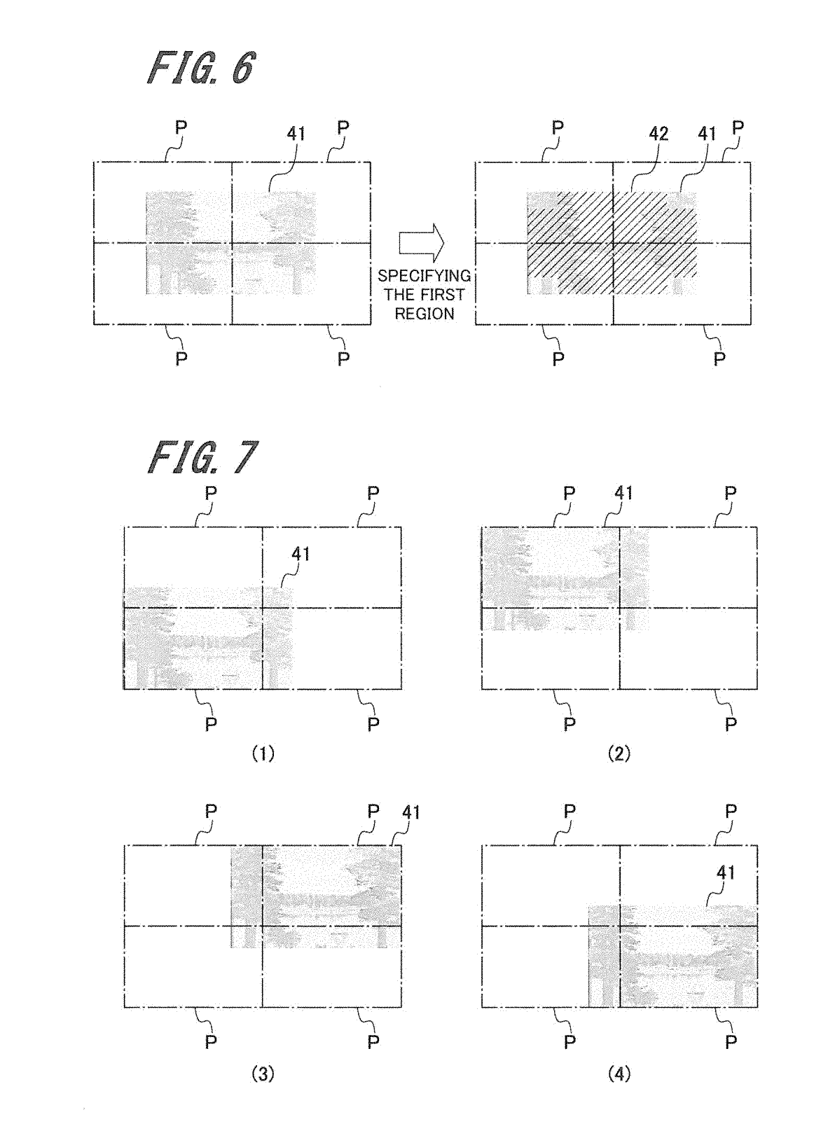

The first region specifier 31 specifies a first region capable of placing a plurality of printout joints based on the document image acquired from the poster print job. The first region will be described in detail with reference to FIGS. 6 and 7. The first region merely represents a region capable of splitting the document image. The first region varies with a sheet size and the number of sheets corresponding to the document image size. The present embodiment produces printouts of a document image by splitting the document image into four sheets each of which is smaller than the document image.

The conspicuousness degree calculator 32 calculates the conspicuousness degree of a unit region with reference to the whole document image when the unit region is contained in the document image and is given a specified position. The unit region signifies a specifically sized block containing one or more pixels of the document image. The conspicuousness degree calculator 32 extracts at least one of edge information, luminance information, and hue information found from the document image and calculates the conspicuousness degree of each unit region based on at least one of the extracted edge information, luminance information, and hue information.

The conspicuousness degree calculator 32 acquires a plurality of images by sampling the document image more than once, enlarges each of the images to the same size as the document image to generate a first image group, and extracts edge characteristics of each image contained in the first image group to generate a second image group. The conspicuousness degree calculator 32 extracts luminance characteristics of each image contained in the first image group to generate a third image group and extracts R (red), G (green), B (blue), and Y (yellow) hue characteristics of each image contained in the first image group to generate a fourth image group. The conspicuousness degree calculator 32 calculates the conspicuousness degree of each unit region based on at least one of the second image group, the third image group, and the fourth image group. The conspicuousness degree calculator 32 extracts a difference between R (red) and G (green) images contained in the fourth image group to generate a fifth image group and extracts a difference between B (blue) and Y (yellow) images contained in the fourth image group to generate a sixth image group. The conspicuousness degree calculator 32 generates a conspicuousness map by normalizing and totaling the second image group, the third image group, the fifth image group, and the sixth image group.

The present embodiment describes the human visual perceptibility as “conspicuousness” and describes the numeric representation of the conspicuousness as a “conspicuousness degree.” For example, a high conspicuousness degree results from part of an object that is viewed by the human and causes the human retina to intensely react. The conspicuousness map provides an image representing the distribution of degrees (conspicuousness degrees) of the human visual perceptibility with reference to the whole document image.

The joint position settler 33 settles a joint position to place a joint, namely, the position that passes through the first region specified by the first region specifier 31 and does not pass through a unit region assigned the conspicuousness degree higher than a predetermined threshold value. The joint position is settled at the position that does not pass through the unit region assigned a high conspicuousness degree. The human visual attention is therefore not directed to a plurality of printout joints. It is possible to improve the visibility of a poster comprised of tiled printouts.

When a poster background color is specified, the joint position settler 33 specifies a joint position, namely, the position that passes through the first region and does not pass through the second region. As will be described in detail later with reference to FIG. 5, the poster background color is specified by a user and corresponds to the color of a wall to attach a printout or the color of a sheet itself. A document image is interrupted by the poster background color, if visible, at the joint position where printouts are tiled, degrading the visibility. However, the joint position settler 33 settles the joint position at the position that passes through the first region and does not pass through the second region. The visibility, therefore, does not degrade even if the poster background color is visible at the joint position.

Regarding a specified joint position, the joint position settler 33 calculates the conspicuousness degree of each unit region in an image generated from the document image containing a joint drawn in the poster background color, finds a position to minimize the sum of conspicuousness degrees at joint positions, and settles this position as a joint position. When no poster background color is specified, the joint position settler 33 settles a joint position, namely, the position that passes through the first region and does not pass through the second region and minimizes the sum of conspicuousness degrees. The joint position is thus settled at the position that minimizes the sum of conspicuousness degrees. The human visual attention is therefore not directed to the joint position even when a plurality of printouts are tiled. The visibility does not degrade.

The second region specifier 34 specifies a second region that causes the conspicuousness degree to be higher than a predetermined threshold value in the document image. The storage 12 stores the threshold value referenced to specify the second region, for example. A user can change the threshold value as needed by using the manipulation displayer 22.

The background color acquirer 35 acquires the poster background color specified by the user via the manipulation displayer 22. The background color acquirer 35 may directly acquire the poster background color input from the manipulation displayer 22 or may read the poster background color temporarily stored in the storage 12 from the storage 12.

When the user selects normal printing as a print mode (see FIG. 5 described later), the background color acquirer 35 acquires a wall color specified by the user as the poster background color from the storage 12. When the user selects bordered printing as a print mode, the background color acquirer 35 acquires a sheet color specified by the user as the poster background color from the storage 12.

The background color acquirer 35 determines that no poster background color is specified when no wall color is specified although the user selects normal printing as the print mode, when no sheet color is specified although the user selects bordered printing as the print mode, or when the user selects overlapped printing as the print mode. In this case, the background color acquirer 35 does not acquire the poster background color.

The description below explains a process of the controller 15 to find a joint from the document image.

The description below first explains three types of print modes depending on how printouts are tiled to create a poster by tiling printouts.

FIG. 5 is an explanatory diagram illustrating printouts generated by three types of print modes. The following describes a print mode to print images on sheets P1 and P2 when two sheets P1 and P2 are tiled to create one poster.

“Normal printing” at the left side of FIG. 5 corresponds to the print mode capable of creating one poster by tiling sheets P1 and P2 without leaving a gap between the right edge of sheet P1 and the left edge of sheet P2. No white space is provided for sheets P1 and P2. The color of a wall to attach sheets P1 and P2 may be viewable from a gap between sheets P1 and P2 and may be conspicuous depending on how sheets P1 and P2 are tiled.

“Bordered printing” at the center of FIG. 5 corresponds to the print mode capable of creating one poster by using a border, namely, a white space (a rectangular frame represented by a dot-and-dash line in the drawing) provided for the left edge of sheet P2 and allowing the right edge of sheet P1 to overlap the border. In this mode, the paper color of part of the border may be conspicuous if sheet P1 incorrectly overlaps the border provided for sheet P2.

“Overlapped printing” at the right side of FIG. 5 corresponds to the print mode capable of creating one poster by printing the document image to extend to a white space (a rectangular frame represented by a dot-and-dash line in the drawing) provided for sheet P2, allowing the right edge of sheet P1 to overlap sheet P2. In this print mode, the document image is printed to partially extend to the white space of sheet P2. The misalignment between images on tiled sheets P1 and P2 is therefore hardly conspicuous.

The user uses the manipulation displayer 22, for example, to select the print mode used for poster printing. However, the print mode may be selected from the PC terminal 2 connected to the image forming apparatus 10. For example, the storage 12 stores the print mode selected by the user. The image processor 11 reads the print mode as needed.

When the user selects “normal printing” as the print mode, the user can further specify “wall color,” namely, the color of a wall to attach the poster. The joint position settler 33 can thereby settle the joint position in consideration of the wall color visible from a gap between sheets P1 and P2 that are printed in the normal printing and are tiled.

The user can specify “sheet color,” namely, the color of sheets for printing when selecting “bordered printing” as the print mode. The joint position settler 33 can thereby settle the joint position in consideration of the sheet color visible from part of the border remaining in sheet P2 when sheets P1 and P2 are tiled so that the right edge of sheet P1 overlaps the border provided for sheet P2.

The description below explains the first region, the second region, and the conspicuousness map needed to settle a printout joint position used to print a poster in multiple pieces. The present embodiment settles a joint in the document image so that the printout joint position is not allocated to a position given a high conspicuousness degree.

The first region will be described first.

FIG. 6 is an explanatory diagram illustrating a first region 42. The first region specifier 31 specifies the first region 42 capable of providing a joint for a document image 41 read from the storage 12.

The left part of FIG. 6 illustrates the document image 41 stored in the storage 12. A lakeside landscape is drawn in the document image 41, for example. The size of sheet P corresponds to each rectangular frame surrounded by a dot-and-dash line in the drawing. A joint position corresponds to edges of adjacent sheets P. The size of document image 41 is larger than sheet P for the image forming apparatus 10 to print. The document image 41 is separately printed on four sheets P. One poster can be created by tiling four sheets P, two vertically and two horizontally.

The description below explains an example of shifting the document image 41 as a precondition of specifying the first region.

FIG. 7 is an explanatory diagram illustrating an example of shifting the document image 41 within four sheets P placed flat.

It is necessary to find a position capable of shifting the document image 41 within four sheets P placed flat when creating a poster by tiling four sheets P to the size of the document image 41. The top left part (1) of FIG. 7 shows an example of placing the document image 41 at the bottom left of four sheets P. The top right part (2) of FIG. 7 shows an example of placing the document image 41 at the top left of four sheets P. The bottom left part (3) of FIG. 7 shows an example of placing the document image 41 at the top right of four sheets P. The bottom right part (4) of FIG. 7 shows an example of placing the document image 41 at the bottom right of four sheets P.

A region capable of shifting the document image 41 within four sheets P is specified as the first region 42 at the right side of FIG. 6. The first region 42 is represented as a shaded portion similar to a cross shape on the document image 41 at the right side of FIG. 6, for example.

The description below explains the second region specified by generating the conspicuousness map.

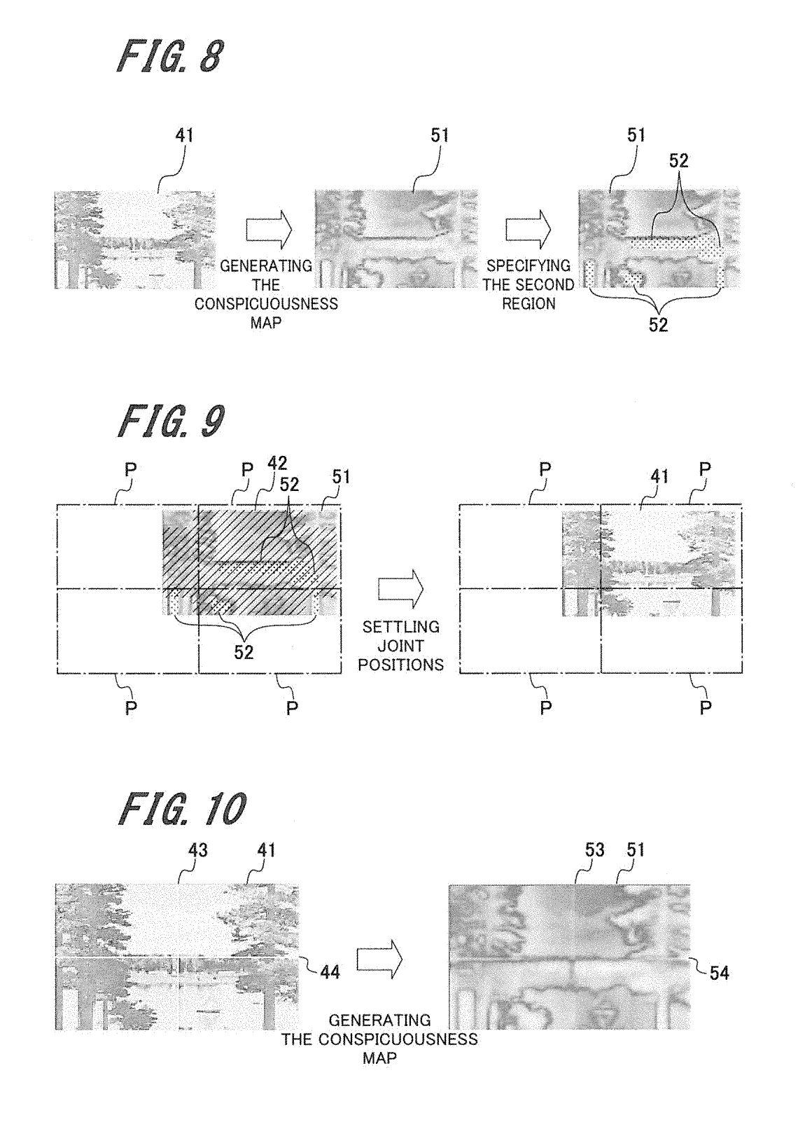

FIG. 8 is an explanatory diagram illustrating a conspicuousness map 51 generated from the document image 41 and a second region 52 specified from the conspicuousness map 51. The conspicuousness map 51 is generated from the color document image 41.

The conspicuousness degree calculator 32 generates the conspicuousness map 51 illustrated at the center of FIG. 8 based on the document image 41 illustrated at the left of FIG. 8. The conspicuousness map 51 shows that intensifying the black decreases the conspicuousness degree and intensifying the white increases the conspicuousness degree. Based on the conspicuousness map 51, the second region specifier 34 specifies the second region 52, namely, the region that causes the conspicuousness degree to be higher than the predetermined threshold value.

The right part of FIG. 8 illustrates the second region 52 specified by the second region specifier 34. The inside of the conspicuousness map 51 specifies a plurality of second regions 52. The second region 52 is assigned a high conspicuousness degree. Placing a joint for sheet P in the second region 52 makes the joint conspicuous when sheets P are tiled. The second region 52, therefore, needs to avoid a joint for sheet P.

The description below explains an example of settling a joint position for sheet P.

FIG. 9 is an explanatory diagram illustrating a joint position for sheet P settled without specifying a poster background color.

When no poster background color is specified, the joint position settler 33 settles a joint position, namely, the position where a joint given to the document image 41 passes through the first region 42 and does not pass through the second region 52 and the sum of conspicuousness degrees of pixels belonging to the joint is minimized. The left side of FIG. 9 illustrates the document image 41 simultaneously showing the first region 42 and the second region 52 at the top right of four sheets P. Joints for sheet P pass through the first region 42 and do not pass through the second region 52 when the document image 41 is placed within four sheets P as above. The joint position is settled as the position that passes through the first region 42 and does not pass through the second region 52.

When four sheets P are tiled, the edge of sheet P is inconspicuous at the joint position of the document image 41 illustrated at the right side of FIG. 9. Therefore, joints are hardly recognizable to a person who views a poster of the document image 41 comprised of a plurality of sheets P.

FIG. 10 is an explanatory diagram illustrating generation of a conspicuousness map based on a document image containing white joints drawn when using white as a poster background color. The poster background color specified here corresponds to a wall color or a sheet color, for example.

The left side of FIG. 10 shows a vertical white line 43 and a horizontal white line 44 to overlap with each other at the center of the document image 41. The white color used for the white lines 43 and 44 is equal to the paper color or the wall color of the wall to attach the poster and is acquired by the background color acquirer 35.

When the user specifies the poster background color, the joint position settler 33 draws the white lines 43 and 44 in the document image 41 based on the color specified as the poster background color. The joint position settler 33 generates the conspicuousness map 51 concerning all joints passing through the second region 42 and not passing through the second region 52 based on the edge information, the hue information, and the luminance information acquired from the document image 41 containing the white lines 43 and 44 drawn and represented as joints. The joint position settler 33 settles the joint position, namely, the position that minimizes the sum of conspicuousness degrees for pixels belonging to the joint.

The conspicuousness map 51 illustrated at the right side of FIG. 10 shows second regions 53 and 54 assigned high conspicuousness degrees. The second region 53 corresponds to the position of the white line 43 drawn in the document image 41. The second region 54 corresponds to the position of the white line 44 drawn in the document image 41. The conspicuousness degree for the joint can be confirmed by previously drawing a joint in the color specified as the poster background color in the document image 41. When the conspicuousness degree for the joint is higher than a threshold value, the joint position settler 33 settles the joint position by shifting the joint to the position that passes through the first region 42 and does not pass through the second region 52 and causes the conspicuousness degree for the joint to be lower than the threshold value. Joints of the printout attached to the wall can be inconspicuous.

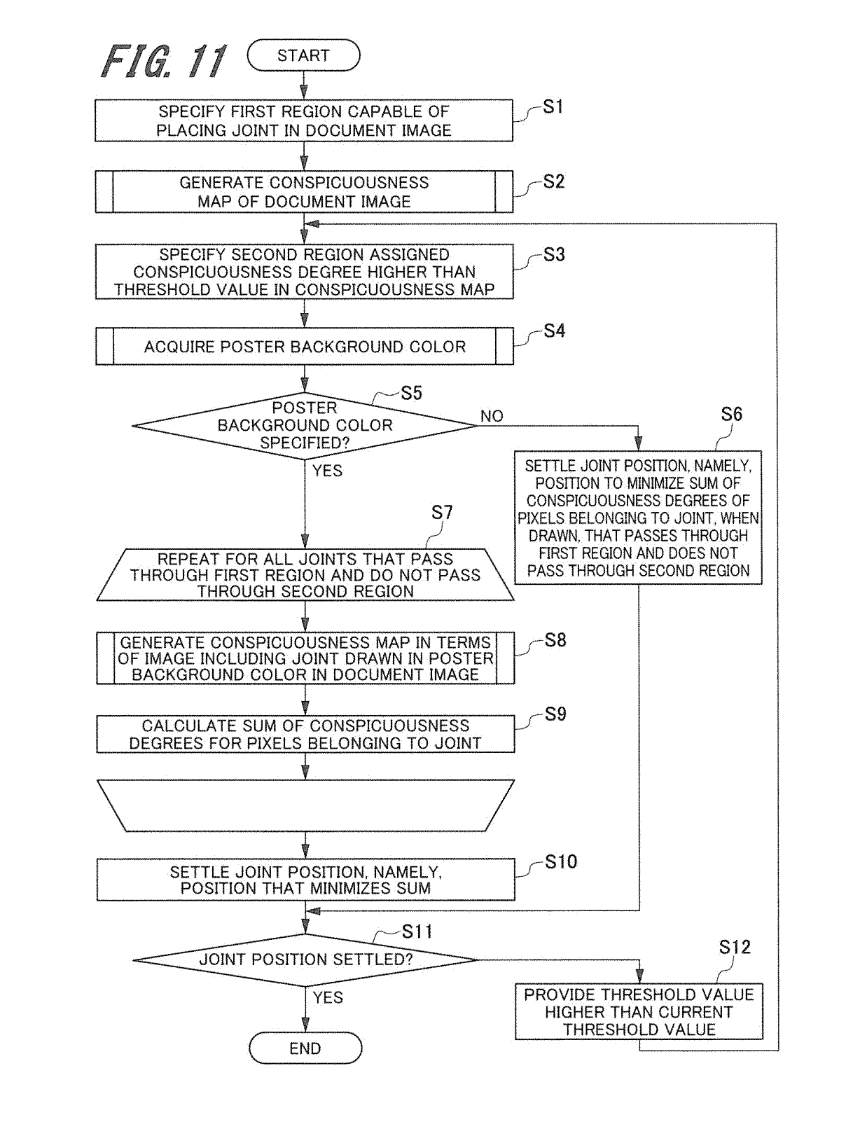

The description below explains a process to settle the printout joint position with reference to FIGS. 11 through 13.

FIG. 11 is a flowchart illustrating the process to settle the printout joint position.

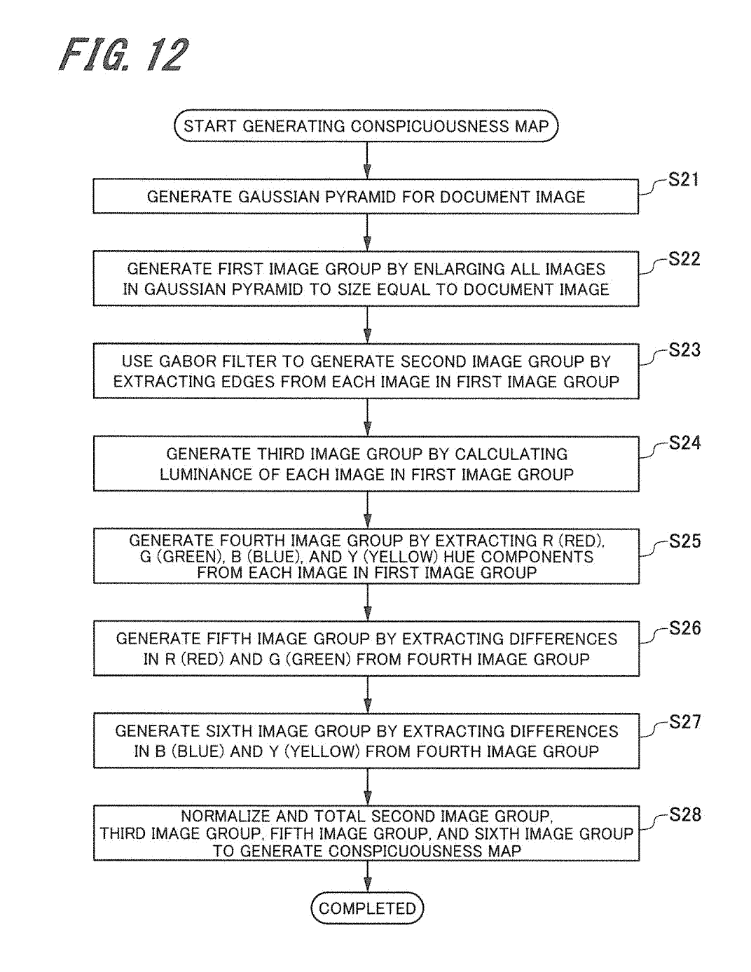

The first region specifier 31 specifies the first region 42 (see FIG. 6) capable of placing a joint in the document image 41 (S1). The conspicuousness degree calculator 32 generates the conspicuousness map 51 of the document image 41 (S2). The process of the conspicuousness degree calculator 32 to generate the conspicuousness map 51 will be described in detail with reference to FIG. 12.

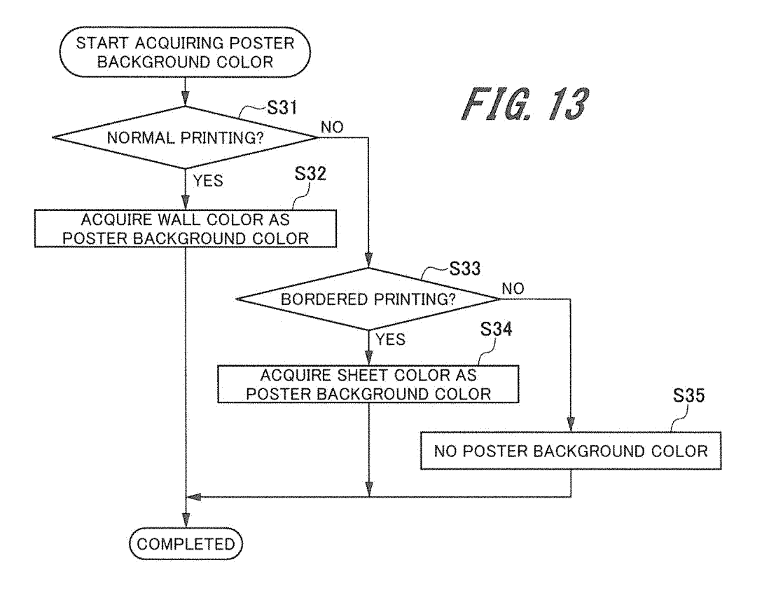

After step S2, the second region specifier 34 specifies the second region 52 assigned a conspicuousness degree higher than the threshold value in the generated conspicuousness map 51 (S3). The background color acquirer 35 acquires the poster background color that is specified from the manipulation displayer 22 and is stored in the storage 12 (S4). The process of the background color acquirer 35 to acquire the poster background color will be described in detail with reference to FIG. 13.

After step S4, the joint position settler 33 determines whether the poster background color is specified (S5). If it is determined that no poster background color is specified (NO at S5), the joint position settler 33 settles the joint position, namely, the position that minimizes the sum of conspicuousness degrees of pixels belonging to a joint that passes through the first region 42 and does not pass through the second region 52 and is drawn in the conspicuousness map 51 (S6). The joint position settler 33 proceeds to the process at step S11.

If it is determined at step S5 that the poster background color is settled (YES at S5), the process at steps S8 and S9 is repeated for all joints that pass through the first region 42 and do not pass through the second region (S7).

At this time, the conspicuousness degree calculator 32 generates the conspicuousness map 51 in terms of an image including a joint drawn in the poster background color in the document image 41 (S8). The process at step S8 to generate the conspicuousness map 51 is equal to the process at step S2 to generate the conspicuousness map 51. The joint position settler 33 calculates the sum of conspicuousness degrees for pixels belonging to the joint (S9).

When the repetition of the process at steps S8 and S9 terminates in terms of all joints that pass through the first region 42 and do not pass through the second region 52, the joint position settler 33 settles the joint position, namely, the position that minimizes the sum of conspicuousness degrees for pixels belonging to the joint (S10).

The joint position settler 33 determines whether the joint position is settled (S11). The process terminates if determining that the joint position is settled (YES at S11). If the process determines that no joint position is settled (NO at S11), the second region specifier 34 provides a threshold value higher than the current threshold value (S12), returns to step S3, and continues the process at step S3 and later. The joint position cannot be settled when the second region 52 appears anywhere in the conspicuousness map 51 due to the current low value, for example. In this case, the second region specifier 34 provides a threshold value higher than the current threshold value to decrease the number of second regions 52 appearing in the conspicuousness map 51, making it possible to easily settle the joint position.

FIG. 12 is a flowchart illustrating a process of the conspicuousness degree calculator 32 to generate the conspicuousness map 51. The process as illustrated in FIG. 12 is performed at steps S2 and S8 in FIG. 11.

The conspicuousness degree calculator 32 first uses a Gaussian filter to generate the Gaussian pyramid for the document image 41 (S21). The Gaussian filter provides an averaging procedure that calculates a weighted average based on the Gaussian distribution function from values of a targeted pixel and pixels around the targeted pixel. The weighted average is used as a pixel value after the process. The Gaussian pyramid provides a set of images having different resolutions generated from an image by decreasing the image size in quarter increments, for example.

The conspicuousness degree calculator 32 enlarges all images in the Gaussian pyramid to the size equal to the document image 41 and generates a first image group comprised of a group of images enlarged to the size equal to the document image 41 (S22). The conspicuousness degree calculator 32 uses a Gabor filter to generate a second image group by extracting edges from each image in the first image group (S23). The Gabor filter is used to extract the direction (such as vertical, horizontal, or slant) of an edge contained in the image, for example. The second image group is used as edge information about each image contained in the Gaussian pyramid.

The conspicuousness degree calculator 32 generates a third image group by calculating the luminance of each image in the first image group (S24). The third image group is used as luminance information about each image contained in the Gaussian pyramid.

The conspicuousness degree calculator 32 generates a fourth image group by extracting R (red), G (green), B (blue), and Y (yellow) hue components from each image in the first image group (S25). The conspicuousness degree calculator 32 generates a fifth image group by extracting differences in the R (red) and G (green) hue components from the fourth image group (S26). The conspicuousness degree calculator 32 generates a sixth image group by extracting differences in the B (blue) and Y (yellow) hue components from the fourth image group (S27). The fourth image group, the fifth image group, and the sixth image group are used as color information about each image contained in the Gaussian pyramid.

The conspicuousness degree calculator 32 normalizes and totals the edge information from the second image group, the luminance information from the third image group, and the hue information from the fifth image group and the sixth image group to generate the conspicuousness map 51 resulting from calculating conspicuousness degrees of the pixels in consideration of the edge, the luminance, and the hue of the whole image (S28). The conspicuousness degree calculator 32 can also generate the conspicuousness map 51 by calculating the conspicuousness degree for each unit region based on at least one of the edge information from the second image group, the luminance information from the third image group, and the hue information from the fifth image group and the sixth image group.

FIG. 13 is a flowchart illustrating a process of the background color acquirer 35 to acquire a poster background color from the storage 12. The process illustrated in FIG. 13 is performed at step S4 in FIG. 11.

The background color acquirer 35 first determines whether normal printing is specified as the print mode (S31). If the process determines that the normal printing is specified, the background color acquirer 35 acquires the poster background color, namely, the user-specified color of the wall to attach printouts from the storage (S32), and terminates the process.

If the process determines at step S31 that the normal printing is not specified, the background color acquirer 35 determines whether bordered printing is specified as the print mode (S33). If the process determines that the bordered printing is specified, the background color acquirer 35 acquires the poster background color, namely, the user-specified color of sheet P (S34), and terminates the process.

If the process determines at step S33 that the bordered printing is not specified, the background color acquirer 35 assumes the poster background color to be unavailable (S35) and terminates the process.

As above, the image forming apparatus 10 according to the first embodiment acquires the conspicuousness degree to indicate the human visual perceptibility and the position information about a part whose conspicuousness degree exceeds the threshold value, based on the edge information, the luminance information, and the hue information acquired from the whole document image 41 during poster printing to generate one poster by tiling a plurality of printouts. The image forming apparatus 10 settles the joint position to avoid a high conspicuousness degree, making it possible to provide a printout joint at the position to avoid the second region 52 causing a remarkable reaction to the human vision in the whole document image 41. It is possible to prevent the visibility from degrading due to joints in the whole poster that is created by tiling a plurality of printouts on a wall, for example, and is viewed by a person.

### Second Embodiment

The description below explains the image forming system according to the second embodiment of the present invention. According to the present embodiment, a print controller used as an example of the information processing apparatus settles a plurality of printout joint positions based on a poster print job.

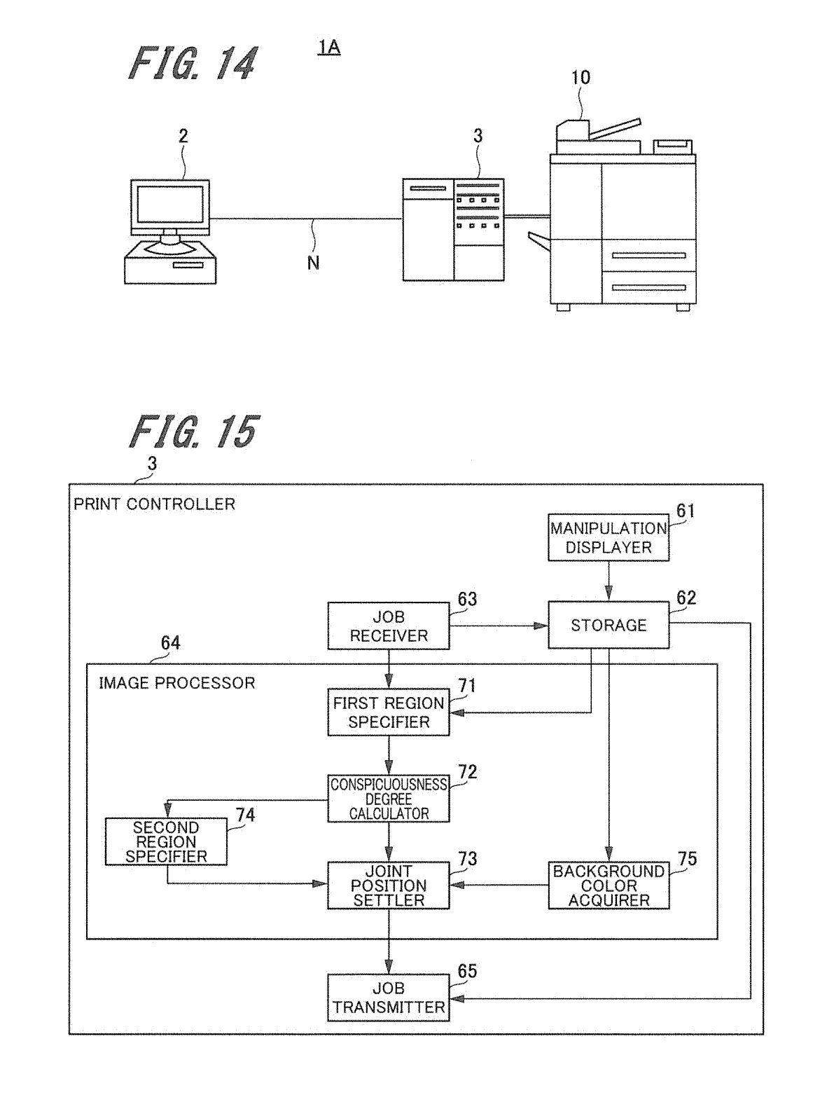

FIG. 14 is a schematic diagram illustrating a configuration of an image forming system 1A.

The image forming system 1A includes a print controller 3 (an example of the information processing apparatus) in addition to the PC terminal 2 and the image forming apparatus 10 connected to communication network N.

The print controller 3 settles a plurality of printout joint positions for a plurality of printouts generated by the image forming apparatus 10 at positions to avoid the human visibility from degrading, based on a poster print job transmitted from the PC terminal 2. The print controller 3 transmits the poster print job to the image forming apparatus 10 to notify the image forming apparatus 10 of the settled joint position. The image forming apparatus 10 can thereby generate a plurality of printouts at the joint position settled by the print controller 3.

FIG. 15 is a block diagram illustrating an internal configuration of the print controller 3.

The print controller 3 includes a manipulation displayer 61, a storage 62, a job receiver 63, an image processor 64, and a job transmitter 65.

The manipulation displayer 61 is comprised of a touch panel including an LCD, for example, and enables a user to perform operations and display the information. The present embodiment uses the manipulation displayer 22 for the user to specify a poster background color.

The storage 62 is provided as RAM or HDD, for example, and stores various types of data such as a poster print job received by the job receiver 63 or a document image processed by the image processor 64. The storage 62 also stores a poster background color specified from the manipulation displayer 61.

The image processor 64 performs a predetermined process on a document image acquired from a poster print job stored in the storage 62. The image processor 64 may perform the process immediately after the job receiver 63 receives the poster print job. The image processor 64 includes a first region specifier 71, a conspicuousness degree calculator 72, a joint position settler 73, a second region specifier 74, and a background color acquirer 75. The components included in the image processor 64 perform processes equal to those performed by the components included in the image processor 11 according to the first embodiment described above. The description below concisely explains the processes of the components included in the image processor 64.

The first region specifier 71 specifies a first region capable of placing a plurality of printout joints based on a document image acquired from the poster print job.

The conspicuousness degree calculator 72 calculates the conspicuousness degree of a unit region with reference to the whole document image when the unit region is contained in the document image and is given a specified position.

The joint position settler 73 settles a joint position to place a joint, namely, the position that passes through the first region specified by the first region specifier 71 and does not pass through the unit region assigned a high conspicuousness degree.

The second region specifier 74 specifies a second region that causes the conspicuousness degree to be higher than a predetermined threshold value in the document image.

The background color acquirer 75 acquires the poster background color specified by the user via the manipulation displayer 22.

The job transmitter 65 transmits the poster print job read from the storage 62 to the image forming apparatus 10 and notifies the image forming apparatus 10 of a plurality of printout joint positions settled by the joint position settler 73.

The image forming apparatus 10 generates a printout based on the poster print job received from the job transmitter 65. The printout generated by the image forming apparatus 10 includes a joint at the joint position settled by the joint position settler 73.

The print controller 3 according to the above-mentioned second embodiment calculates a conspicuousness degree for the document image to settle a joint position. The image forming apparatus 10 generates a plurality of printouts at the joint position settled by the print controller 3. It is possible to prevent the visibility from degrading due to joints in the whole poster that is created by tiling a plurality of printouts on a wall, for example, and is viewed by a person.

The first and second embodiments described above use the conspicuousness map 51 to calculate the conspicuousness degree and settle the joint position. The joint position may be settled by dividing the document image into blocks and calculating the conspicuousness degree for each block.

The present invention is not limited to the above-mentioned embodiments. It is further understood by those skilled in the art that various applications and modifications may be made in the present invention without departing from the spirit and scope thereof described in the appended claims.

For example, the above-mentioned embodiments describe, in detail and specifically, configurations of the apparatuses and the system in order to explain the present invention for simplicity but are not limited to an entity including all the configurations that have been described. The configuration of one of the above-mentioned embodiments can be partially replaced by the configuration of another embodiment. The configuration of one embodiment can be added to the configuration of another embodiment. The configuration of each embodiment can be partially subject to addition, deletion, or replacement of another configuration.

The control lines or the information lines are provided on condition that they are considered necessary for the sake of description. The description does not cover all control lines or information lines as products. Actually, almost all the configurations can be connected to each other.

Although embodiments of the present invention have been described and illustrated in detail, the disclosed embodiments are made for purposes of illustration and example only and not limitation. The scope of the present invention should be interpreted by terms of the appended claims.

### REFERENCE SIGNS LIST

1 . . . image forming system, 2 . . . PC terminal, 3 . . . print controller, 10 . . . image forming apparatus, 11 . . . image processor, 12 . . . storage, 13 . . . print processor, 14 . . . job receiver, 15 . . . controller, 22 manipulation displayer, 31 . . . first region specifier, 32 . . . conspicuousness degree calculator, 33 . . . joint position settler, 34 . . . second region specifier, 35 . . . background color acquirer, 41 . . . document image, 42 . . . first region, 52 . . . second region

What is claimed is:

1. An image forming apparatus comprising:
a first region specifier that specifies a first region capable of placing joints of a plurality of printouts based on a document image acquired from a poster print job to print a poster created by tiling the printouts;
a conspicuousness degree calculator that calculates a conspicuousness degree for each unit region included in the document image and assigned a specified position with reference to the whole document image; and
a joint position settler that settles a joint position to place the joint, namely, a position to pass through the first region and not to pass through the unit region assigned the conspicuousness degree higher than a predetermined threshold value.

2. The image forming apparatus according to claim 1,
wherein the conspicuousness degree calculator extracts at least one of edge information, luminance information, and hue information found from the document image and calculates the conspicuousness degree for each of the unit regions based on at least one of the edge information, the luminance information, and the hue information.

3. The image forming apparatus according to claim 2,
wherein the conspicuousness degree calculator yields a plurality of images by sampling the document image more than once and generates a first image group by enlarging each image to the same size as the document image;
generates a second image group by extracting an edge feature of each image included in the first image group;
generates a third image group by extracting a luminance feature of each image included in the first image group;
generates a fourth image group by extracting a hue feature of each image included in the first image group; and
calculates a conspicuousness degree for each of the unit regions based on at least one of the second image group, the third image group, and the fourth image group.

4. The image forming apparatus according to claim 3, further comprising:
a background color acquirer that acquires a user-specified poster background color; and
a second region specifier that specifies a second region assigned the conspicuousness degree higher than a predetermined threshold value in the document image.

5. The image forming apparatus according to claim 4,
wherein, when the poster background color is specified, the joint position settler specifies the joint position, namely, a position to pass through the first region and not to pass through the second region, calculates the conspicuousness degree at the specified joint position for each of the unit regions in an image including a joint drawn in the poster background color in the document image, and settles the joint position, namely, a position to minimize the sum of the conspicuousness degrees at the joint position.

6. The image forming apparatus according to claim 4,
wherein, when a user selects normal printing as a print mode, the background color acquirer acquires the poster background color, namely, a wall color of a wall to attach the printout, the wall color being specified by the user.

7. The image forming apparatus according to claim 4,
wherein, when a user selects bordered printing as a print mode, the background color acquirer acquires the poster background color, namely, a sheet color of a sheet to generate the printout, the sheet color being specified by the user.

8. The image forming apparatus according to claim 4,
wherein, when the poster background color is not specified, the joint position settler settles the joint position, namely, a position to minimize the sum of the conspicuousness degrees at a position to pass through the first region and not to pass through the second region.

9. The image forming apparatus according to claim 4,
wherein the background color acquirer assumes the poster background color to be unspecified in one of cases where no wall color is specified even though a user selects normal printing as a print mode, where a sheet color of a sheet to create the printout is not specified even though the user selects bordered printing as the print mode, and where the user selects overlapped printing as the print mode.

10. An information processing apparatus comprising:
a first region specifier that specifies a first region capable of placing joints of a plurality of printouts based on a document image acquired from a poster print job to print a poster created by tiling the printouts;
a conspicuousness degree calculator that calculates a conspicuousness degree for each unit region included in the document image and assigned a specified position with reference to the whole document image;
a joint position settler that settles a joint position to place the joint, namely, a position to pass through the specified first region and not to pass through the unit region assigned the high conspicuousness degree; and
a job transmitter that transmits the poster print job to an image forming apparatus generating the printout based on the poster print job and notifies the joint position settled by the joint position settler.
